(19) United States
(12) Patent Application Publication
(10) Pub. No.: US 2004/0194045 A1
(43) Pub. Date: Sep. 30, 2004

(54) Electronic circuit design apparatus and method thereof

(75) Inventor: Kazumasa Kobayashi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/798,261

(22) Filed: Mar. 12, 2004

(30) Foreign Application Priority Data
Mar. 31, 2003 (JP) 2003-095724

(51) Int. Cl. G06F 17/50

(52) U.S. Cl. 716/10; 716/4; 716/11

(57) ABSTRACT

At the time of designing an electronic circuit, using both the contour information about a plurality of components to be collectively arranged in the electronic circuit and a layout distance between two of the plurality of components, a contour of the component region for collectively arranging these components is calculated and the calculated contour of the component region is displayed on a screen.

### BACKGROUND OF THE INVENTION

1. Field of the Invention

The present invention relates to an electronic circuit design apparatus, a method of designing an electronic circuit such as a large scale integrated circuit (LSI), a multichip module (MCM), a printed circuit board (PCB), etc., a computer program for causing a computer to carry out the design of such an electronic circuit and a computer-readable storage medium storing such a computer program.

2. Description of the Related Art

In the case of designing an electronic circuit by CAD (Computer Aided Design), there are three design procedures including the first step of setting the global layout and global wiring of a circuit thereby determining a design constraint, the second step of inserting logic design into the circuit and the third step of editing the layout and wiring of the circuit.

Conventionally, in the case of determining the global layout of components to be used in the first step, a designer defines the shapes of components to be arranged, arranges the components one by one and examines the layout. In the method of a layout examination in the third step, layout regions are divided for each function, etc. and the layout of components is examined for each divided region (for example, Japanese Laid-Open Patent Publication No.8-255185). Furthermore, in an automatic layout in the third step, components are temporarily arranged, the thus-temporarily-arranged components are grouped for each function and the layout is examined in detail for each group (for example, Japanese Laid-Open Patent Publication No.4-363767).

However, there are following problems in the above-mentioned conventional electronic circuit design method.

The layout examination in the first step is a global examination and it aims at figuring out the global layout positions and occupied area of the components to be arranged. In spite of such a global examination, in a conventional method of arranging components one by one, it is required that the shapes of components to be examined are defined and arranged manually by a designer so that there arises the problem that an examination time increases.

Even if the method of a layout examination in the third step is tentatively applied to the first step, the occupied area of components cannot be figured out until the components are actually arranged in each section. Eventually, it is required that components are arranged one by one. Therefore, this method is not an effective method of shortening an examination time in the first step.

Even if a method of automatic layout in the third step is tentatively applied to the first step, it is required that the shapes of components to be examined are defined one by one and arranged. Therefore, this method is not an effective method of shortening an examination time in the first step.

### SUMMARY OF THE INVENTION

An object of the present invention is to provide an electronic circuit design apparatus for shortening the examination time of global layout of components in an electronic circuit and a method thereof.

An electronic circuit design apparatus of the present invention is provided with a storage device, an indication device, a calculation device and a display device, and it designs an electronic circuit on a screen. The storage device stores the contour information about each component. The indication device indicates a plurality of components to be collectively arranged in the electronic circuit and a layout distance between the components. The calculation device obtains the contour information about the components from the storage device and calculates a contour of a component region for collectively arranging the components using the obtained contour information and the indicated layout distance. Then, the display device displays the calculated contour of the component region on the screen.

### BRIEF DESCRIPTION OF THE DRAWINGS

FIG. 1 is a drawing showing a principle of an electronic circuit design apparatus of the present invention;

FIG. 2 is a drawing showing a computer system;

FIG. 3 is a configuration drawing of a main body of the computer system;

FIG. 4 is a configuration drawing of software;

FIG. 5 is a drawing explaining component layout without a region;

FIG. 6 is a drawing explaining component layout with a region;

FIG. 7 is a flowchart of a region layout process;

FIG. 8 shows drawings explaining the transformation of a region;

FIG. 9 is a flowchart of a region transformation process;

FIG. 10 is a table showing attributes of component regions;

FIG. 11 is a flowchart of an attribute setting process;

FIG. 12 is a drawing explaining the first division display;

FIG. 13 is a flowchart of the first region division process;

FIG. 14 is a drawing explaining the region display of indicated components;

FIG. 15 is a flowchart of the process of region-displaying the indicated components;

FIG. 16 is a drawing explaining the second division display;

FIG. 17 is a flowchart of the second region division process;

FIG. 18 is a drawing explaining the integration display of a plurality of regions;

FIG. 19 is a flowchart of a region integration process;

FIG. 20 is a drawing showing a component to be region-displayed;

FIG. 21 is a drawing showing a reference component;

FIG. 22 is a drawing showing an initial condition;

FIG. 23 is a drawing showing the first region display;

FIG. 24 is a drawing showing the second region display;

FIG. 25 is a drawing showing the third region display;

FIG. 26 is a drawing showing the forth region display; and

FIG. 27 is a flowchart of a process of displaying a region around a component.

### DESCRIPTION OF THE PREFERRED EMBODIMENTS

The following is the detailed explanation of the preferred embodiments of the present invention in reference to drawings.

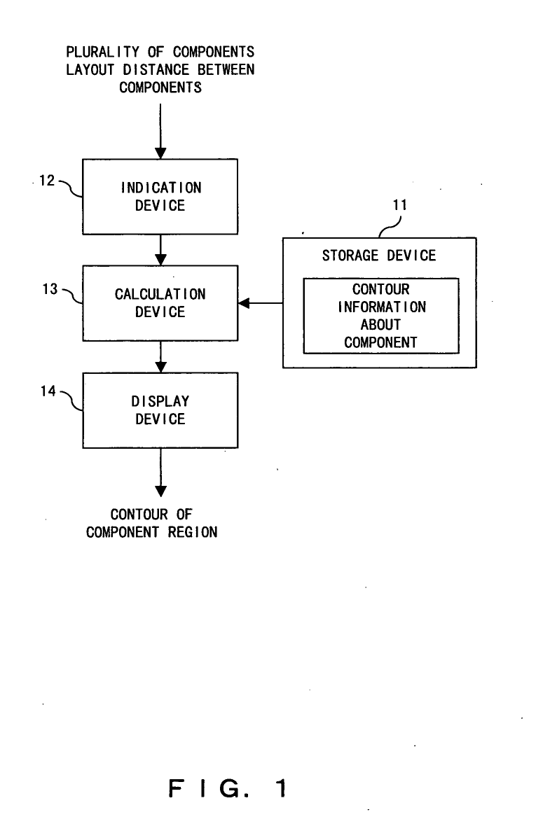

FIG. 1 is the principle drawing of an electronic circuit design apparatus of the present invention. The electronic circuit design apparatus of FIG. 1 is provided with a storage device 11, an indication device 12, a calculation device 13 and a display device 14, and it designs an electronic circuit on a screen.

The storage device 11 stores contour information about each component while the indication device 12 indicates a plurality of components to be collectively arranged in an electronic circuit and a layout distance between those components. The calculation device 13 acquires the contour information about those components from the storage device 11 and calculates a contour of a component region for collectively arranging those components using the acquired contour information and the indicated layout distance. The display device 14 displays the calculated contour of the component region on the screen.

According to such an electronic circuit design apparatus, it is possible to collectively arrange a plurality of components in an electronic circuit as one region and display the region on the screen. In this way, the global layout position and occupied area of components to be arranged can be figured out without individually arranging the components so that an examination time of the global component layout can be shortened.

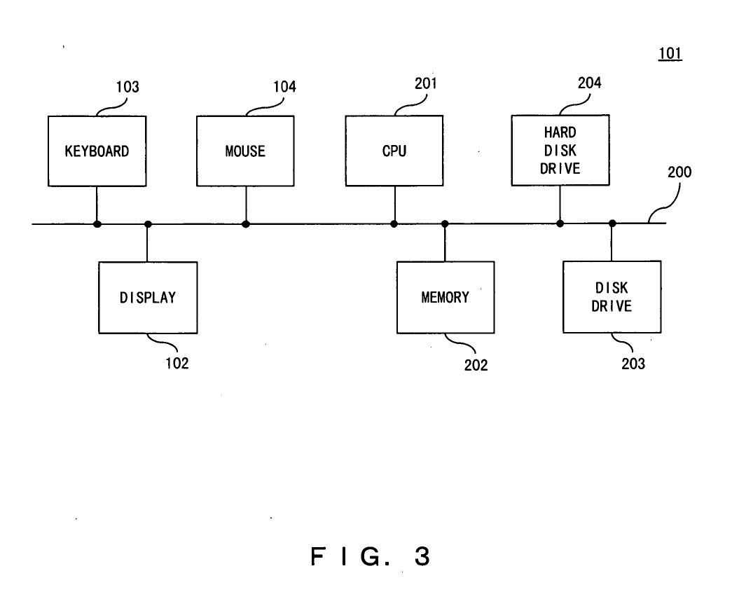

The storage device 11 corresponds to, for example, a hard disc drive 204 shown in FIG. 3 which is described later while the indication device 12 corresponds to, for example, a keyboard 103 and a mouse 104 shown in FIG. 3. Furthermore, the calculation device 13 corresponds to, for example, a CPU (Central Process Unit) 201 and a memory 202 shown in FIG. 3 while the display device 14 corresponds to, for example, a display 102 shown in FIG. 3.

In this preferred embodiment, as a method of global component layout in the first step, a plurality of components are arranged as one region in consideration of the global size and layout distance of the components. In this way, a plurality of components can be effectively arranged, thereby shortening the examination time of a global component layout.

In addition, component layout using a region can be effectively examined by being provided with functions of generating regions in consideration of a relative position relation with other components, transforming, integrating and dividing regions.

Furthermore, it is possible to simulate a transmission waveform, an electromagnetic wave, heat, cost and the others, which is one of the effective methods of examining a design constraint, by enabling a region to have attribute information such as the characteristic value of a component, etc.

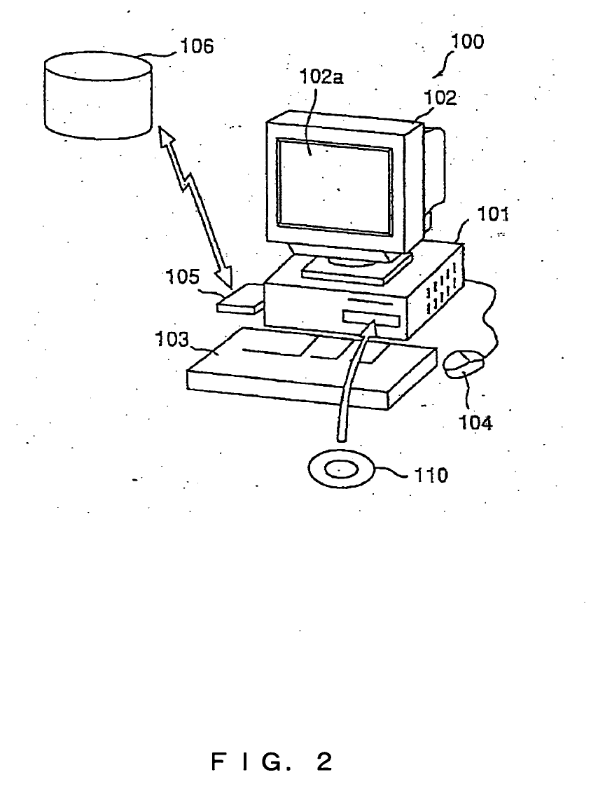

The electronic circuit design apparatus of the present embodiment is intended to design an electronic circuit on a display using CAD and it is configured by, for example, a computer system as shown in FIG. 2.

A computer system 100 shown in FIG. 2 includes a main body 101 incorporating a CPU (Central Process Unit), a disc drive, etc., a display 102 for displaying an image on a display screen 102a based on the indications from the main body 101, a keyboard 103 for inputting different types of information into the computer system 100, a mouse 104 for designating an optional position on the display screen 102a of the display 102 and a modem 105 for accessing an external database, etc. and downloading a computer program or data which are stored in other computer systems.

A computer program (electronic circuit design software) stored in the portable storage medium of a disk 110 etc. or downloaded from a storage medium 106 of the other computer system using a communication apparatus such as the modem 105 etc. is inputted into the computer system 100 to be complied. This complied program causes the computer system 100 to carry out an electronic circuit design process.

Storage media used for storing such a program include various types of storage media which can be accessed by the computer system 100 connected via a communication apparatus such as the modem 105, a LAN (Local Area Network), etc. as well as portable storage media such as the disk 110, an IC (Integrated Circuit) card memory, a flexible disk, a magneto-optical disc, a CD-ROM (Compact Disk Read Only Memory), etc.

FIG. 3 is a block diagram showing the configuration of a substantial part provided within the main body 101 of the computer system 100. The main body 101 of FIG. 3 is configured by the CPU 201, the memory 202 consisting of a RAM (Random Access Memory), a ROM (Read Only Memory) etc., a disc drive 203 used for the disk 110 and a hard disc drive (HDD) 204, which are all connected by a bus 200.

In FIG. 3, the display 102, the keyboard 103 and the mouse 104 are connected to the CPU 201 via the bus 200, but these units may be directly connected to the CPU 201. Furthermore, the display 102 may be connected to the CPU 201 via a well-known graphic interface (not shown in the figure) for processing input-output image data. Furthermore, the configuration of the computer system 100 is not limited to the configuration shown in FIGS. 2 and 3. Instead, various types of well-known configurations may be used.

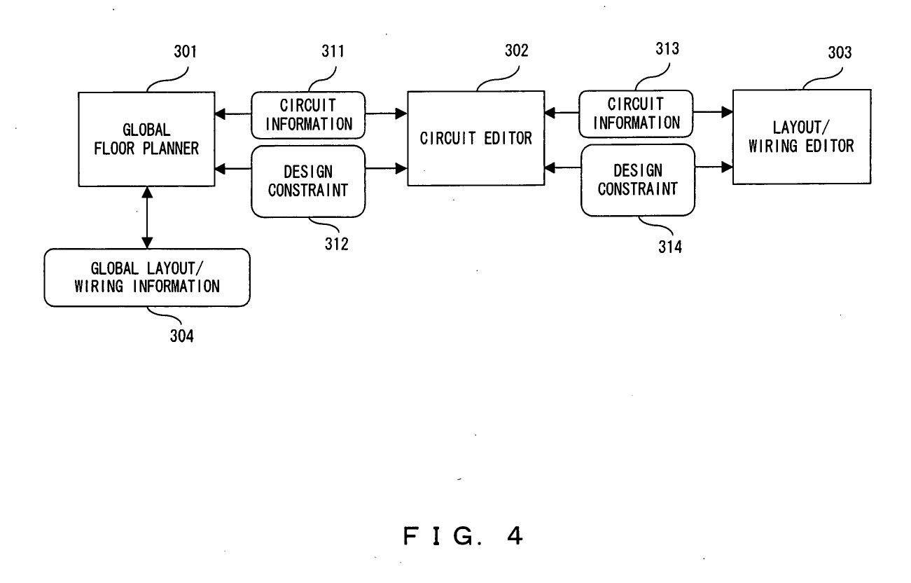

FIG. 4 is a configuration drawing of electronic circuit design software that is installed to an electronic circuit design apparatus configured by the computer system 100. The electronic circuit design software shown in FIG. 4 consists of a global floor planner 301, a circuit editor 302 and a layout/wiring editor 303. These programs respectively support the design in the above-mentioned first, second and third steps.

The global floor planner 301 reads the global layout/wiring information 304 about components and layout, and performs global layout and wiring, thereby displaying the results on the screen. The global layout/wiring information 304 includes both global information about the board contour and the component contour (simplified shape) registered by a user, and information about the component installation position defined by the user. As a component contour, for example, the circumscribed rectangle of a component is used and the lengths (sizes) in height and width of the circumscribed rectangle are registered as the global information. The global layout/wiring information 304 is stored in, for example, the disc drive 204 shown in FIG. 3.

When a user approves the displayed global layout/wiring, the global floor planner 301 outputs circuit information 311 (net list, etc.) and a design constraint 312 (position coordinate, wiring width, etc. of the arranged component).

Then, the circuit editor 302 performs logic design using the circuit information 311 and a design constraint 312, and outputs circuit information 313 and a design constraint 314 to which circuit logic is added. In the case that a design change is required at this moment, the circuit information 311 is returned from the circuit editor 302 to the global floor planner 301, and the global layout and global wiring are carried out once again.

Then, the layout/wiring editor 303 edits the layout and wiring of a circuit based on the circuit information 313 and the design constraint 314. In the case that a design change is required at this moment, the circuit information 313 is returned from the layout/wiring editor 303 to the circuit editor 302 and logic design is carried out once again.

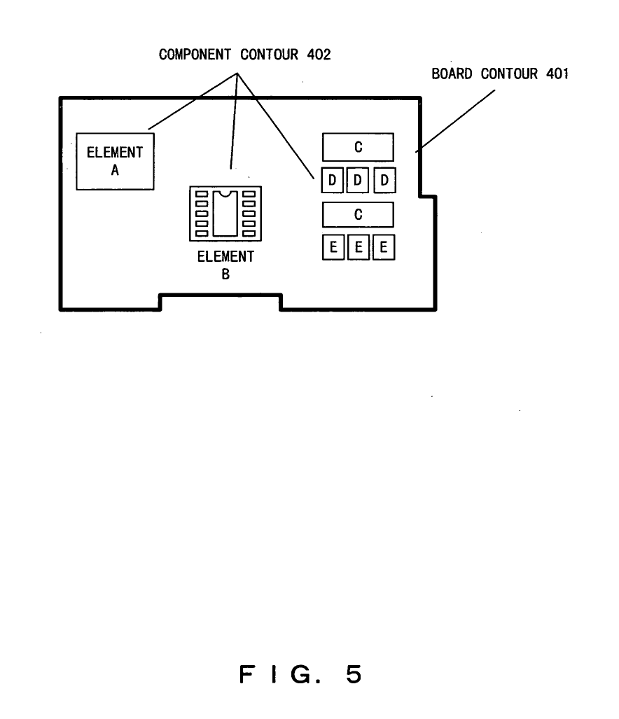

FIG. 5 shows a condition where components are arranged on a displayed board using the global floor planner 301. IA conventional global layout, a component contour 402 is thus defined for each component and the component contours 402 are arranged one by one within a board contour 401. In the example of FIG. 5, five types of components such as elements A, B, C, D and E are used. One element A, one element B, two elements C, three elements D and three elements E are arranged.

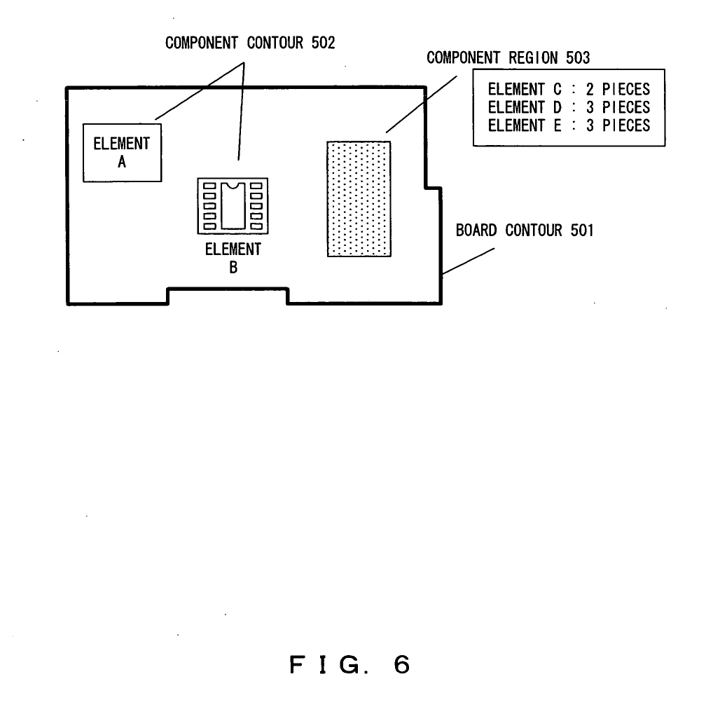

In contrast, when three types of elements C, D and E are collectively arranged as one component region from the beginning as the above-mentioned layout, the screen display becomes like FIG. 6. The use of such a function realizes the operations of collectively arranging a plurality of components and displaying the region like a component region 503, in addition to a function of arranging the component contours 402 one by one within a board contour 501.

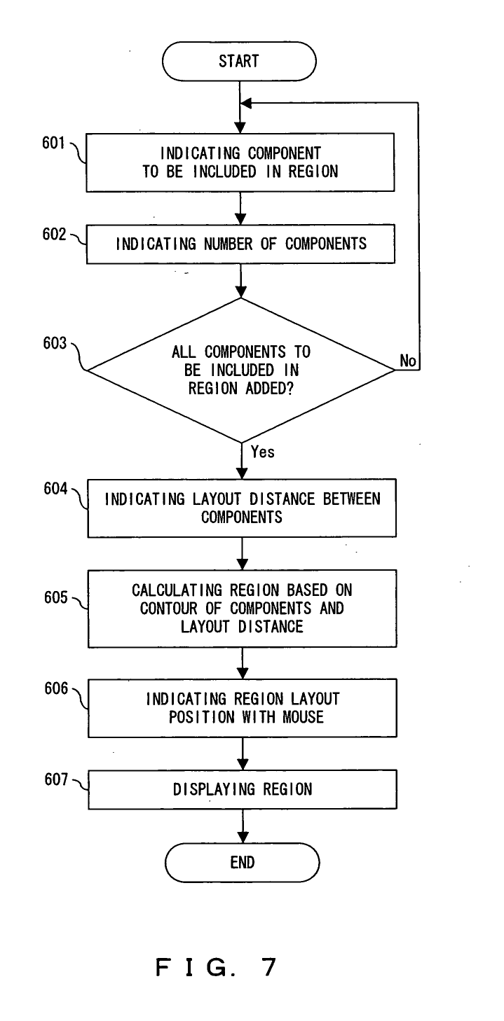

FIG. 7 is a flow chart of such a region layout process. First of all, a user indicates the type of components to be included in a region to the global floor planner 301 (step 602) and also indicates the number of the components (step 601).

Then, the user indicates whether or not components are further added to the region (step 603). In the case of further adding components, the processes in and after step 601 are repeated. When all the components to be included in the region have been added, the user indicates a layout distance between components (step 604). At this moment, the user may designate a different layout distance for each component or may designate a layout distance common to all the components.

After that, the global floor planner 301 calculates a region contour based on the component contour of a component to be included in the region and the indicated layout distance (step 605). For example, in the case of the component region 503 shown in FIG. 6, the region contour is calculated by the following equation.

horizontal length of component region=horizontal length of contour of element C vertical length of component region=(vertical length of contour of element C)×2+(vertical length of contour of element D)+(vertical length of contour of element E)+(vertical component distance)×3

Then, when the user indicates the position for arranging a region with a mouse (step 606), the global floor planner 301 displays the region at the indicated position (step 607). As a method of designating a region layout position, it is conceivable to designate an arbitrary reference point in the region and on a contour (for example, the apex of the region contour), and use the position indicated by the user with the mouse as the position of the reference point.

According to such a region layout process, in a layout examination in the first step, a group of components to be arranged can be easily arranged as one region, thereby shortening the examination time of a global layout in the first step. Furthermore, the necessary data amount can be reduced by simplifying the data to be used for a layout examination, in comparison with a method of individually arranging components.

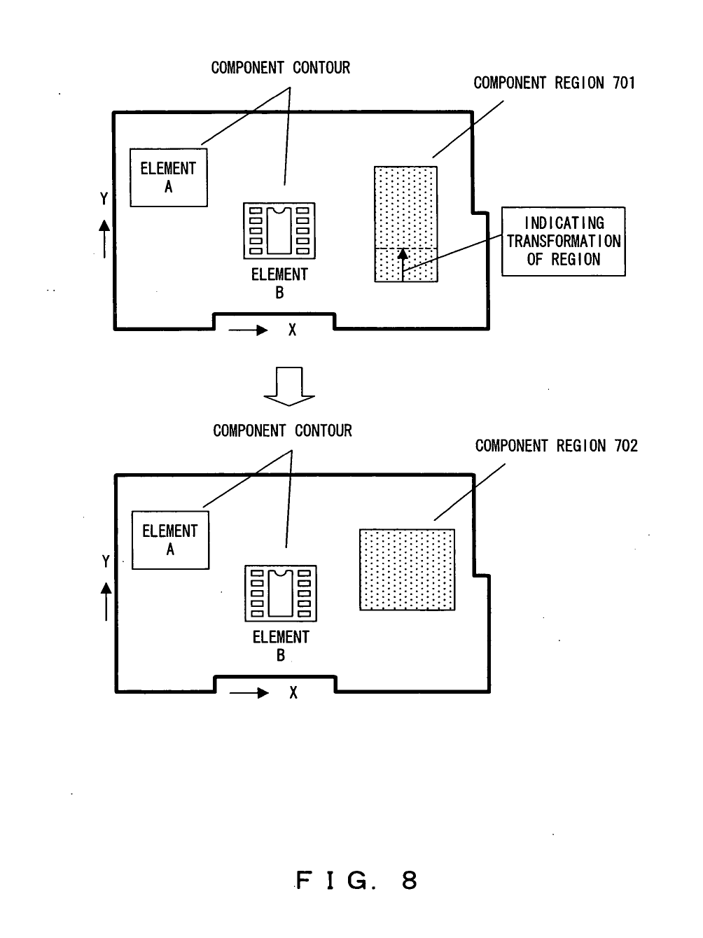

Additionally, the user can freely transform the displayed region. FIG. 8 shows operations of changing the size of a direction Y (vertical direction) of a region and transforming the region. When the user indicates the transformation of a region for a component region 701 shown in FIG. 8, the region contour is re-calculated on the basis of the indicated size and a component region 702 is displayed.

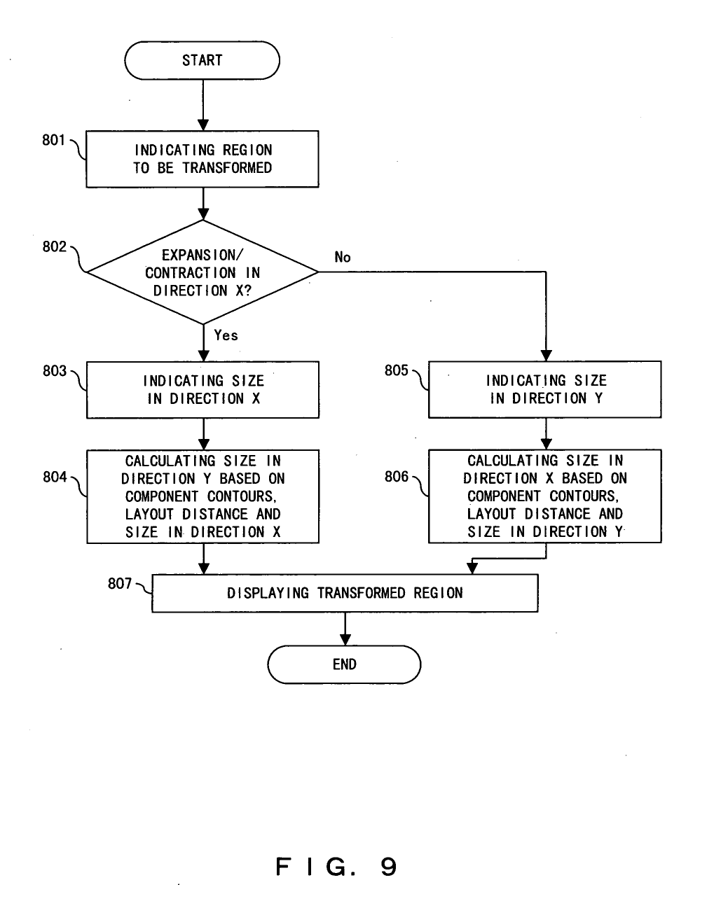

FIG. 9 is a flowchart of such a region transformation process. First of all, the user indicates a component region to be transformed (step 801) and selects an expansion/contraction direction of the region (step 802).

In the case of selecting the direction X, the user indicates a size in the direction X (horizontal length of a region) after transformation (step 803). In this case, the global floor planner 301 calculates a size in the direction Y after transformation based on the current region contour, the component contours of the components, the layout distance and the size in the direction X after transformation (step 804).

In the case of selecting the direction Y, the user indicates a size in the direction Y (vertical length of a region) after transformation (step 805). In this case, the global floor planner 301 calculates a size in the direction X after transformation based on the current region contour, the component contours of components, the layout distance and the size in the direction Y after transformation (step 806).

After that, the global floor planner 301 displays the region by the calculated size after transformation (step 807).

In FIG. 8, since the size in the direction Y is indicated and shortened, the size in the direction X is made longer so as to cover all the components included in the component region 701 and then the component region 702 is generated.

In step 803, an expansion/contraction amount in the direction X may be indicated instead of a size in the direction X while in step 805, an expansion/contraction amount in the direction Y may be indicated instead of a size in the direction Y. In steps 804 and 806, a size after transformation may be determined in such a way that the area of a component region before transformation is equivalent to that after transformation.

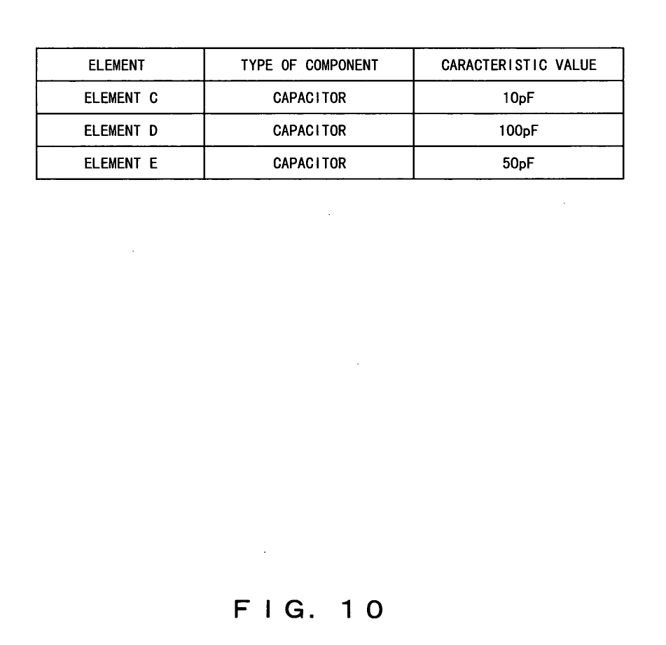

Additionally, the user can set attribute information such as the characteristic value of a component, etc. for the displayed region. FIG. 10 shows one example of the attribute information set for the component region 503 shown in FIG. 6. In this example, a type of each component included in the region (element name: capacitor) and a characteristic value (capacitance) are set as attribute information. In the case that the type of a component is a resistor, the resistance value is set as a characteristic value while in the case that the type of a component is an inductor, an inductance is set as a characteristic value.

In this way, if the type and characteristic value of each component included in a region are set as attribute information, a transmission waveform and a electromagnetic wave can be simulated so that a layout examination becomes possible in consideration of the simulation result.

Furthermore, heat can be simulated if the calorific value of each component included in a region is set as attribute information. If the price of each component included in a region is set as attribute information, a cost can be simulated.

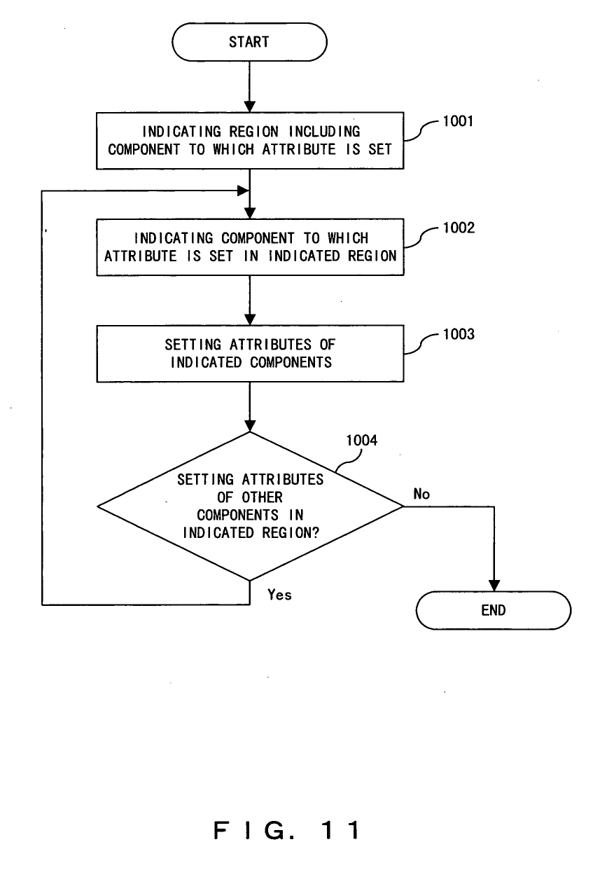

FIG. 11 is a flowchart of an attribute setting process of setting attribute information for the component in a region. First of all, the user indicates to the global floor planner 301, a region including a component to which attribute information is set (step 1001) and a component to which attribute information is set in the region (step 1002). Then, the global floor planner 301 sets attribute information about the component on the basis of a user's indication (step 1003).

Subsequently, the user indicates whether or not the attribute information about other components in the region is set (step 1004). In the case of setting the attribute information about other components, processes in and after step 1002 are repeated. When the attribute information about a required component has been set, processes terminate.

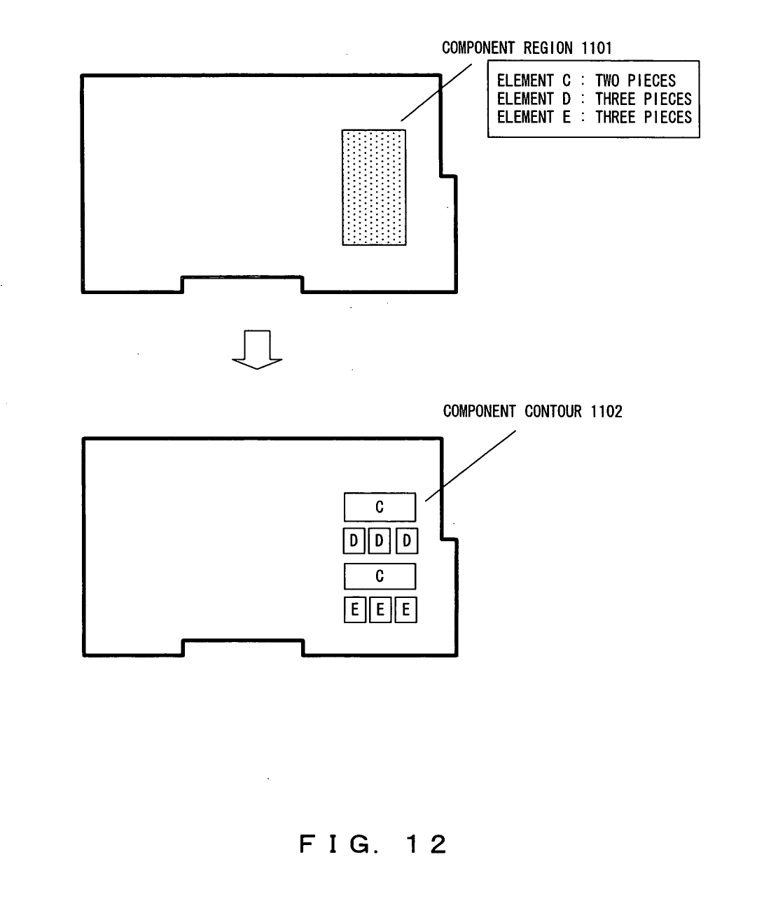

Furthermore, the global floor planner 301 can replace a component group that is displayed as a region with respective components and can separately display the respective components. FIG. 12 shows an operation of dividing a region into respective components and displaying the respective components. When the global floor planner 301 indicates the division display of a component region 1101 that is arranged by a process of FIG. 7, a component group in the region is displayed in the state where the group is divided into respective components like component contours 1102.

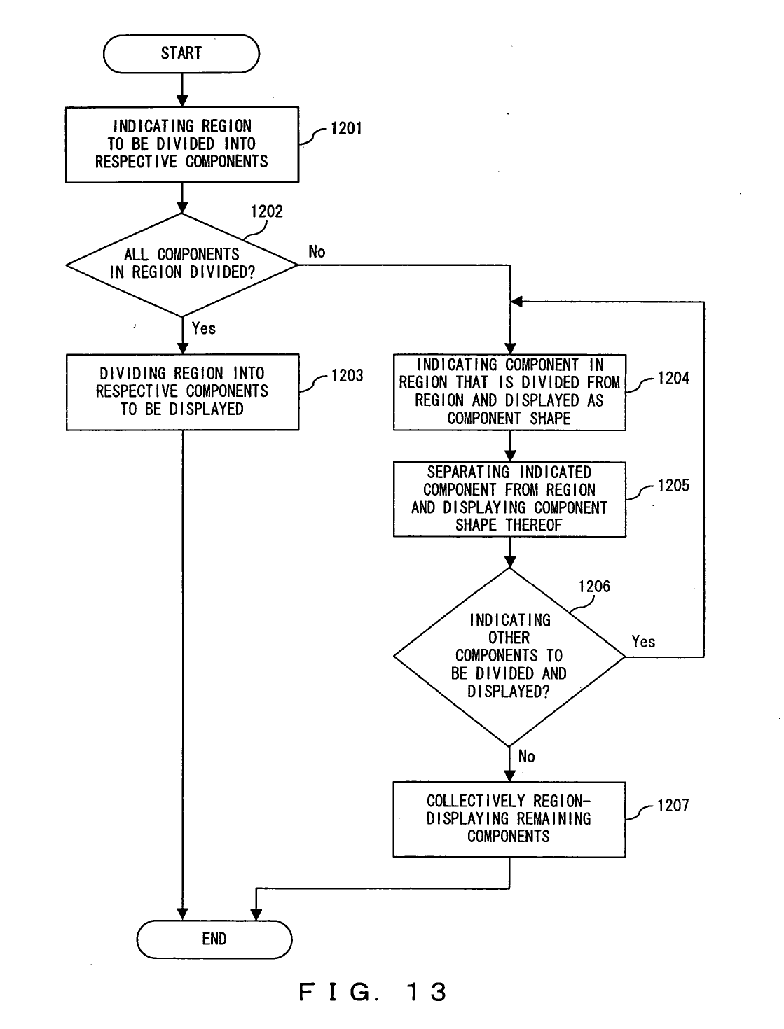

FIG. 13 is a flowchart of such a region division process. First of all, the user indicates a region to be divided to the global floor planner 301 (step 1201) and also indicates whether or not all the components in the region are divided and displayed (step 1202).

In the case that the user indicates all the components in the region to be divided, the global floor planner 301 divides all the components in the region and displays the respective component contours (step 1203).

In the case of dividing part of the components in the region, the user indicates components to be divided and displayed (step 1204), and the global floor planner 301 separates the indicated components from the region, thereby displaying the component contours of them.

Then, the user selects whether or not he/she indicates other components to be divided and displayed (step 1206). In the case of indicating other components, processes in and after step 1204 are repeated. In the case that a user does not indicate other components, the global floor planner 301 collectively region-displays the components remaining in the region (step 1207). The calculation method of a region contour is similar to that in step 605 shown in FIG. 7.

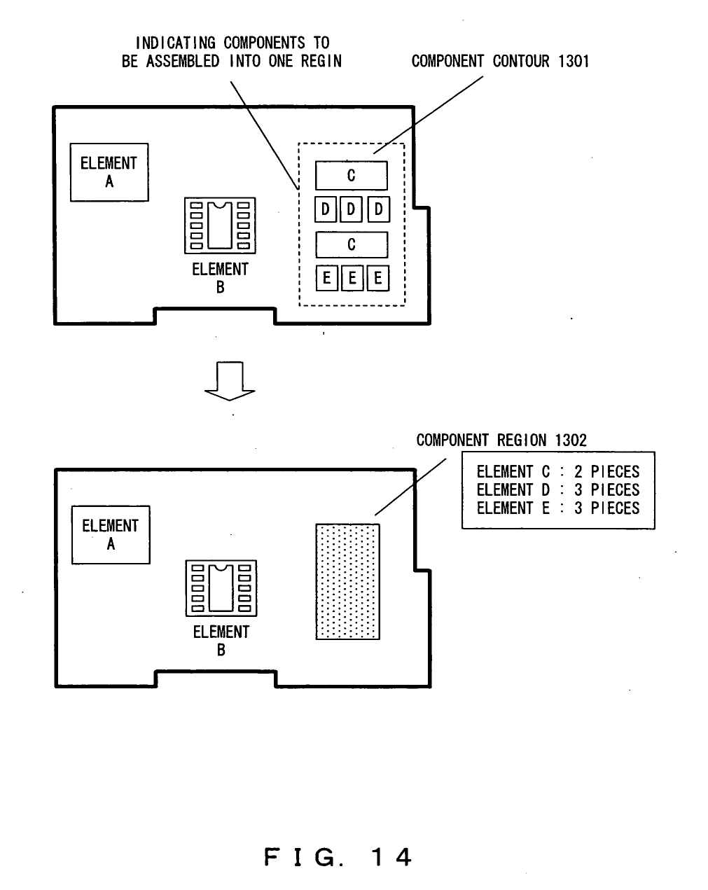

In addition, the global floor planner 301 can collectively display a plurality of individually arranged components as one region. FIG. 14 shows operations of indicating the already-arranged components and region-displaying the components. When indicating the assembly of component contours 1301 of components such as elements C, D and E shown in FIG. 14 into one region, the indicated plurality of components are displayed as one region like a component region 1302.

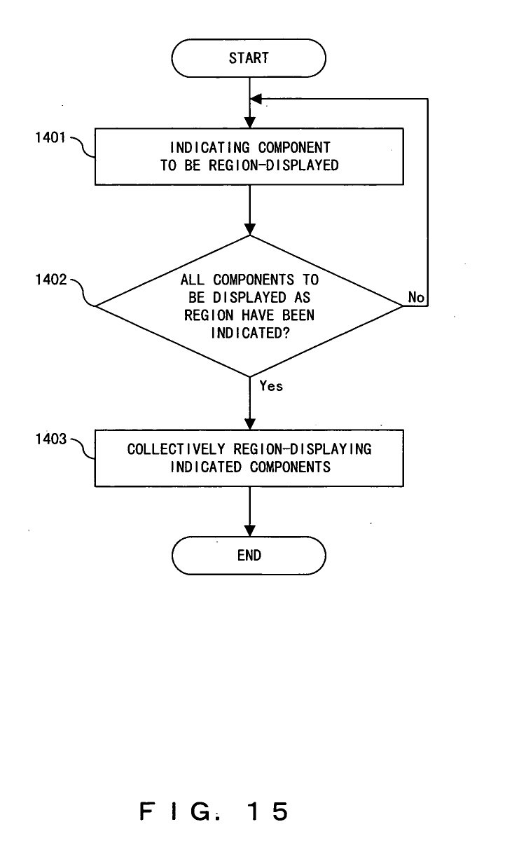

FIG. 15 is a flowchart of a process of region-displaying indicated components. First of all, the user indicates components to be region-displayed (step 1401) and determines whether or not all the components to be region-displayed have been indicated (step 1402). In the case that other components are indicated, processes in and after step 1401 are repeated.

When the user inputs a confirmation that all the components have been indicated, the global floor planner 301 collectively region-displays all the indicated components. The calculation method of a region contour is similar to the step 605 shown in FIG. 7.

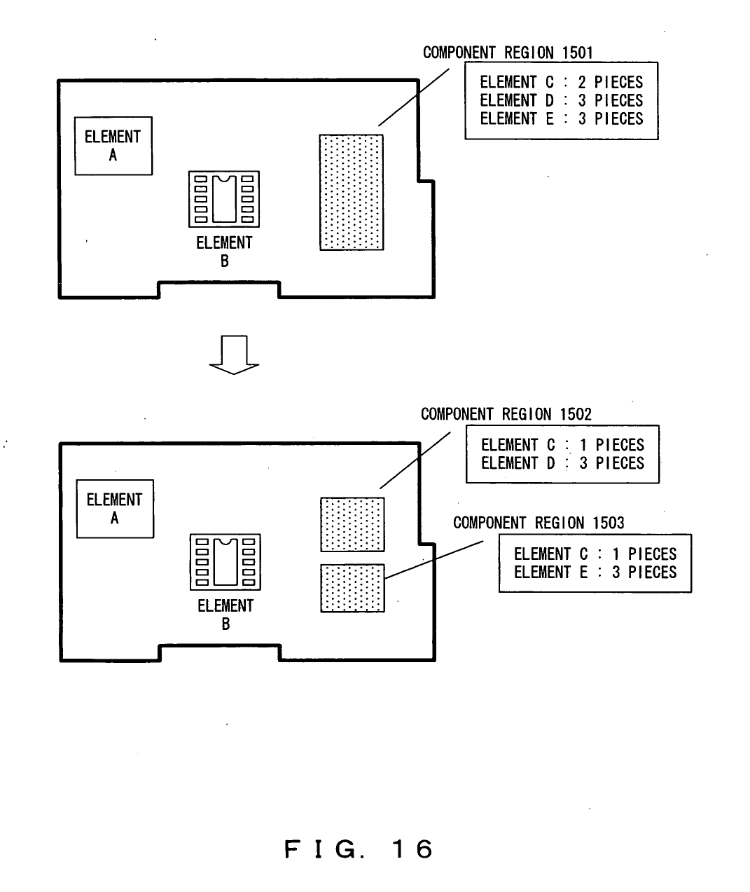

Furthermore, the user can divide the displayed region into a plurality of regions. FIG. 16 shows an operation of dividing a region into two regions and displaying them. When the division of a component region 1501 shown in FIG. 16 is indicated, the region 1501 is divided into a component region 1502 and a component region. 1503 and those regions are displayed. The component region 1502 includes one element C and three elements D while the component region 1503 includes one element C and three elements E.

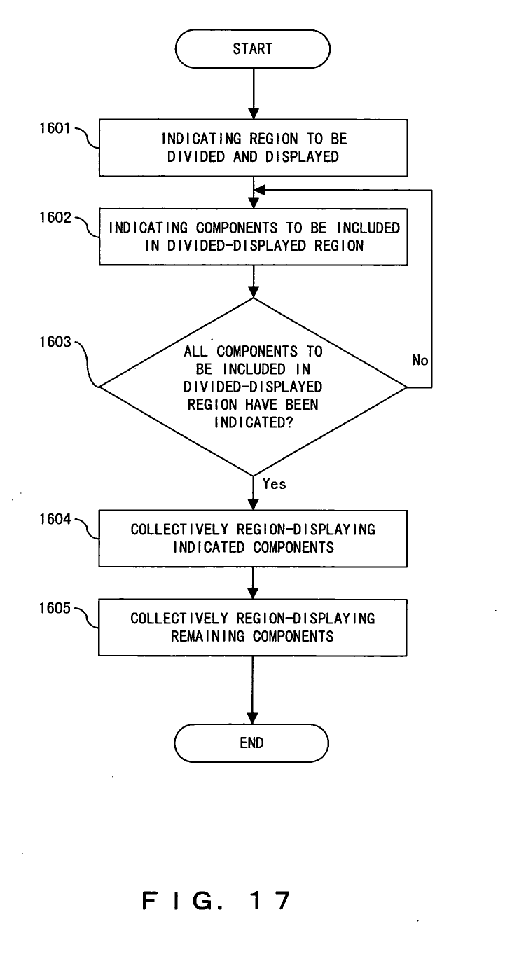

FIG. 17 is a flowchart of such a region division process. First of all, the user indicates a region to be divided and displayed (step 1601), and also indicates components to be included in one of the regions (step 1602). After this, the user determines whether or not all the components to be included in one region have been indicated (step 1603). If the user indicates other components, processes in and after step 1602 are repeated.

When the user inputs a confirmation that all the components to be included in one region have been indicated, the global floor planner 301 collectively region-displays all the indicated components (step 1604) and also collectively region-displays the remaining components (step 1605). The calculation method of a region contour in steps 1604 and 1605 is similar to the step 605 shown in FIG. 7.

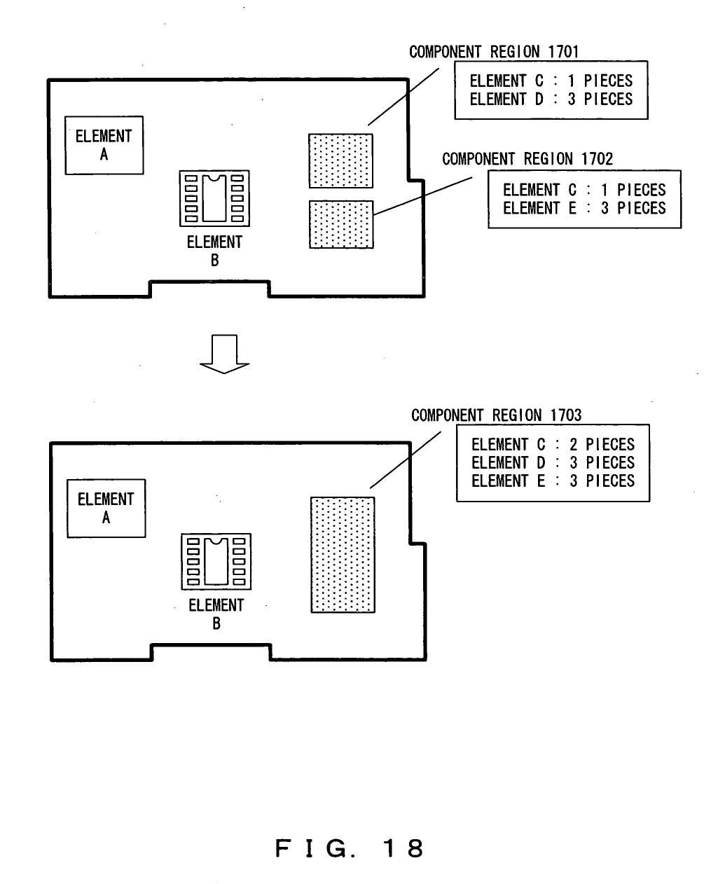

Furthermore, the user can integrate a plurality of indicated regions into one region. FIG. 18 shows an operation of integrating and displaying two regions. When the integration of a component region 1701 and a component region 1702 shown in FIG. 18 is indicated, these component regions are integrated into one component region 1703 and it is displayed.

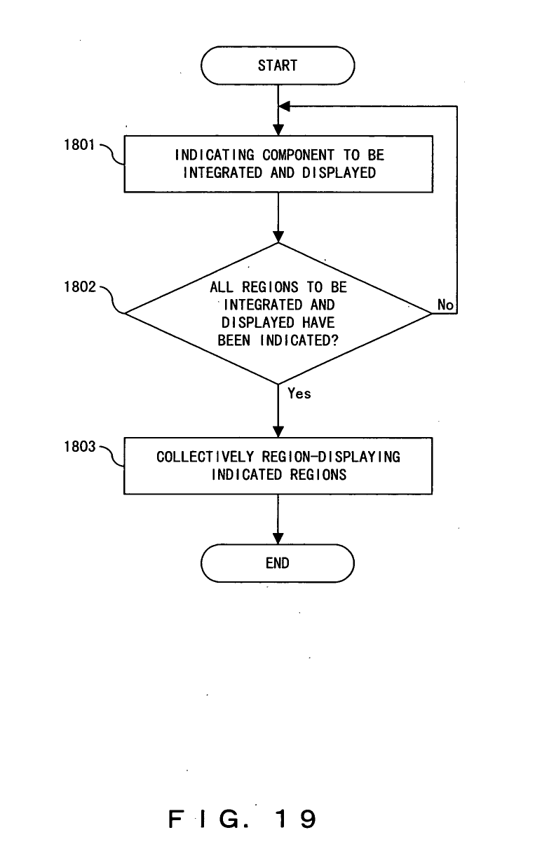

FIG. 19 is a flowchart of such a region integration process. First of all, the user indicates a plurality of regions to be integrated and displayed (step 1801), and also determines whether or not all the regions to be integrated and displayed have been indicated (step 1802). If the user indicates other regions, processes in and after step 1801 are repeated.

When the user inputs a confirmation that all the regions have been indicated, the global floor planner 301 collectively region-displays all the indicated regions (step 1803). Here, using a region contour of each indicated region instead of a component contour, a new region contour is calculated by the method similar to the step 605 shown in FIG. 7.

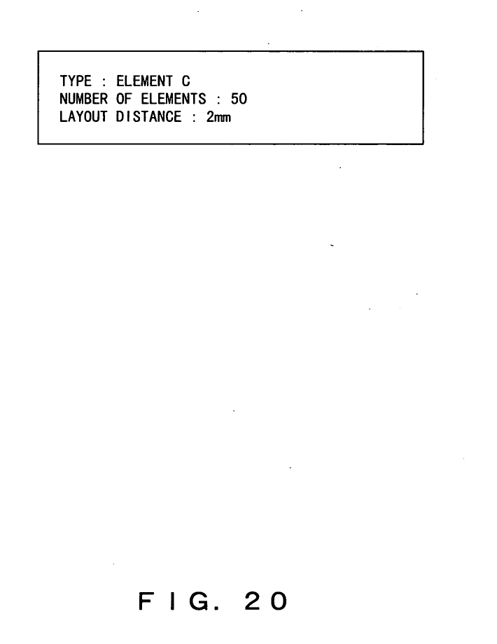

Furthermore, the global floor planner 301 can perform region display in consideration of the relative position relation with surrounding components. FIGS. 20 to 26 show examples of region display in the case that a plurality of components of one type are arranged around a square reference component. In addition, even a plurality of types of components can be included in a region. Furthermore, the shape of the reference component is not limited to square and any other shapes can be adopted.

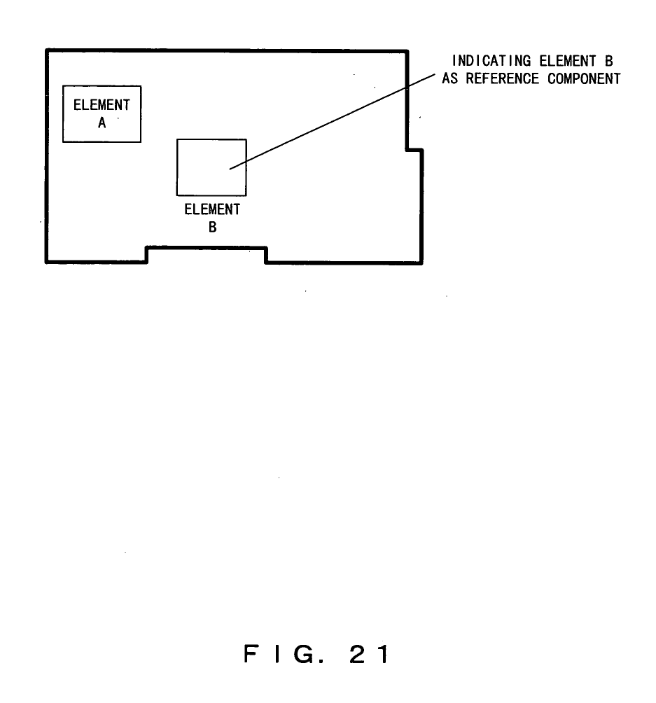

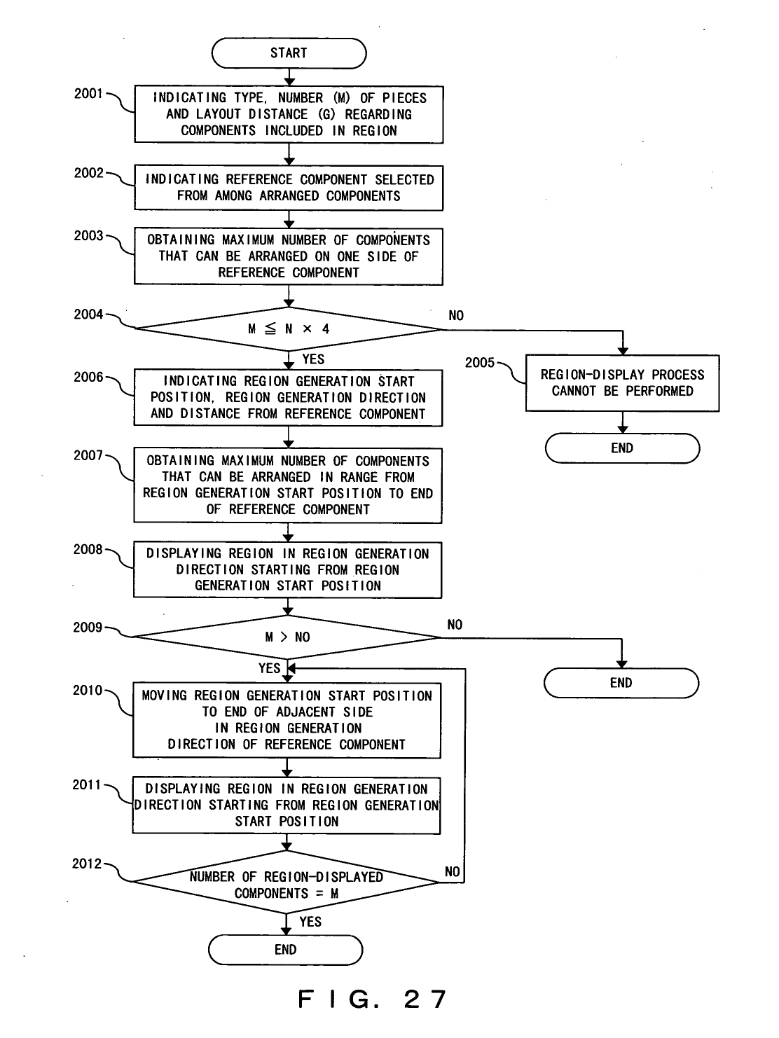

FIG. 27 is a flowchart of the process of displaying regions along the surrounding of a reference component. First of all, the user indicates the type of components, the number of components M and a layout distance G between components to be included in a region (step 2001), and indicates a component to be a reference component from among arranged components (step 2002). In FIG. 20, an element C is designated as the type of components, fifty is designated as the number of components M and 2 mm is designated as the layout distance G. In Fig. 21, an element B is designated as the reference component.

Then, the global floor planner 301 calculates the maximum number of the indicated components that can be arranged at one side of the reference component based on the indicated layout distance in reference to the component contour (step 2003). Specifically, the maximum value of such N that satisfies the following equation is obtained by setting as W the width of a component included in a region and the thus-obtained maximum value is stored as N.

width of reference component>W×N+G×(N−1)

Then, it is determined whether or not the number of components (N×4) that can be arranged around the reference component is equal to or greater than the indicated number M (step 2004). If M>N×4, it is determined that a region-display process cannot be performed under the indicated condition (step 2005) and the process terminates.

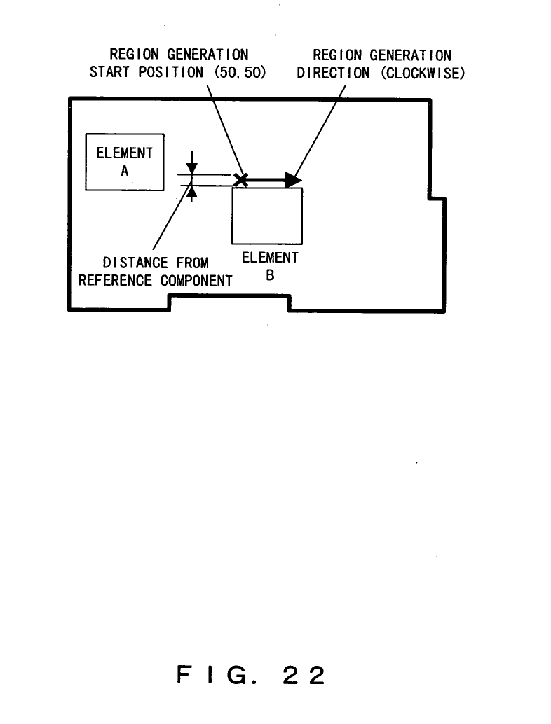

If M≦N×4, a region generation start position, a region generation direction and a distance from a reference component that are initial conditions of region generation are inquired for a user (step 2006). In FIG. 22, a coordinate (50,50) is indicated as the region generation start position, a clockwise direction is indicated as the region generation direction and 10 mm is indicated as the distance from the reference component.

When the user indicates the initial condition of region generation, the global floor planner 301 calculates the maximum number of components that can be arranged as the region in the range from the region generation start position to the end of the reference component toward the region generation direction (step 2007). Specifically, the maximum value of such N0 that satisfies the following equation is obtained and the obtained maximum value is stored as N0.

length from region generation start position to end of reference component toward region generation direction≧W×N0+G×(N0−1)

Then, the width required for region display is calculated and the region is displayed using the obtained width (step 2008). Specifically, a region width is obtained by the following equation using Min (N0, M) representing the smaller value between the obtained N0 and the indicated number M.

region width=W×Min(N0, M)+G×(Min(N0, M)−1)

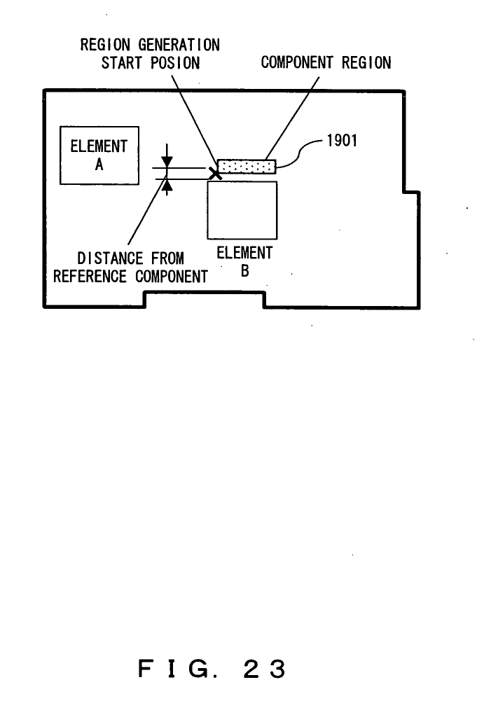

FIG. 23 shows a display example of the case that M is equal to or greater than N0. In this case, a component region 1901 is displayed using a value close to the length measured from the region generation start position to the end of the reference component as the region width.

Subsequently, it is determined whether or not M is greater than N0 (step 2009). In the case of M≦N0, all the components of the indicated number M have been displayed as a region in step 2008 so that the process terminates.

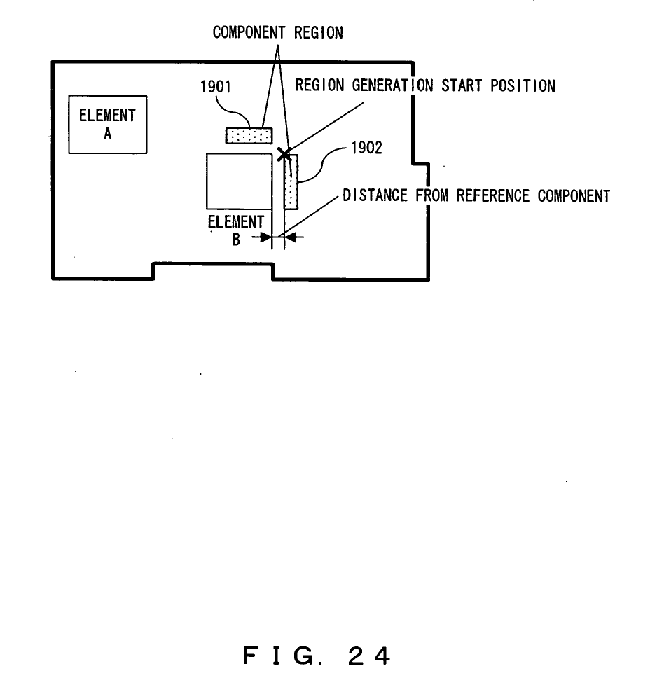

In the case of M>N0, components remain as not-displayed so that an additional region display process is performed (steps 2010 to 2012). At first, the region generation start position is moved to the end of the adjacent side in the region generation direction of the reference component (step 2010). In FIG. 24, X corresponds to the moved start position.

After that, a width required for a region display process is calculated and a region is displayed based on the calculated width (step 2011). Here, a region width is obtained by the following equation using Min(N, (M-number of region-displayed components)) that represents the smaller value between the maximum number N of components obtained in step 2003 and the number of not-region-displayed components (M-number of region-displayed components).

region width=W×Min(N, (M-number of region-displayed components))+G×(Min(N, (M-number of region-displayed components))−1)

In FIG. 24, a component region 1902 is displayed using the value close to a length measured from the moved region generation start position to the end of the reference component (length of one side of the reference component) as the region width.

Then, it is determined whether or not the number of region-displayed components reaches M (step 2012). If the number of region-displayed components does not reach M, processes in and after step 2010 are repeated. When all the M components have been displayed, the process terminates.

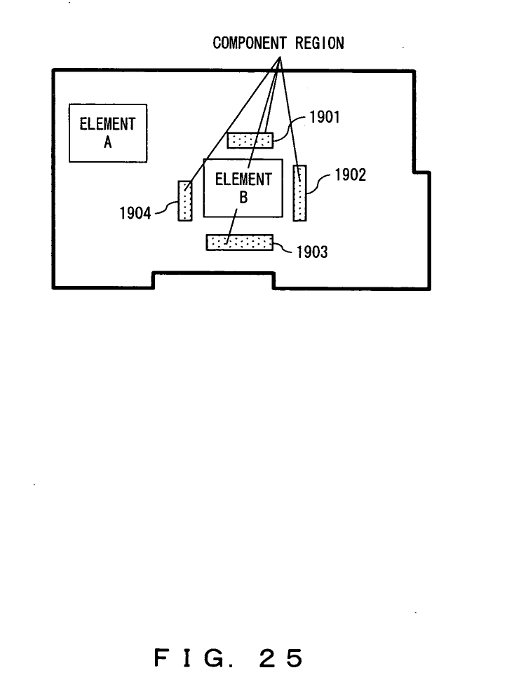

In this way, all the indicated components are region-displayed as shown in FIG. 25. In FIG. 25, four component regions 1901, 1902, 1903 and 1904 are displayed along the surrounding of the reference component.

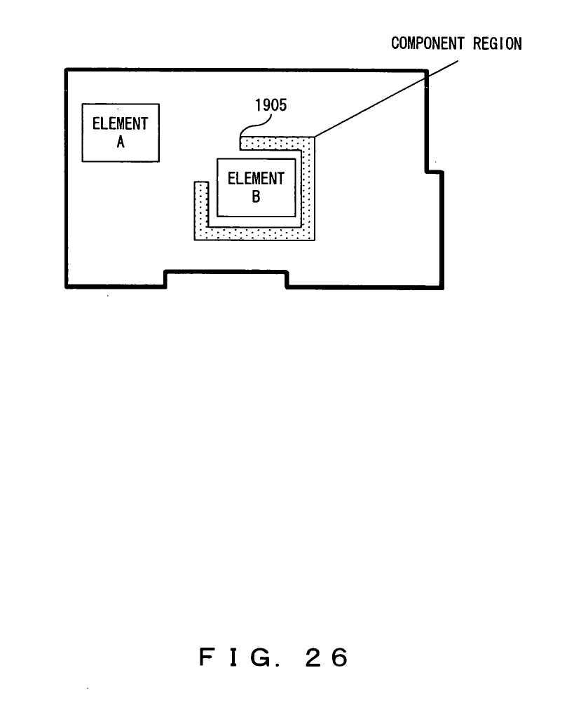

In this example, one rectangle component region is generated for each side of the reference component but it is possible to concatenate these regions into one component region and display it. In this case, a component region 1905 is displayed as shown in FIG. 26.

In the above-mentioned preferred embodiment, a circumscribed rectangle of a component is used as a component contour but other arbitrary shapes (polygon, etc.) can be used as component contours. Furthermore, an electronic circuit design method of the present invention can be applied to various types of circuit design such as a large scale integrated circuit, a multichip module, a printed circuit board, etc.

According to the present invention, when a global layout is examined at the upstream stage of electronic circuit design, it is possible to collectively arrange a plurality of components as one region in consideration of the global size and layout distance between components. In this way, the global layout position and occupied area of components to be arranged can be figured out without individually arranging components so that the examination time of a global component layout can be shortened.

Furthermore, a component layout can be effectively examined using a region by being provided with functions of generation in consideration of the relative position relation with other components, the transformation, integration and division of regions.

Furthermore, it is possible to simulate a transmission waveform, an electromagnetic wave, heat, cost, etc., which is one of the effective methods of examining a design constraint, by enabling a region to have attribute information such as the characteristic value of a component, etc.

What is claimed is:

1. An electronic circuit design apparatus for designing an electronic circuit on a screen, comprising:
a storage device to store contour information about each component;
an indication device to indicate a plurality of components to be collectively arranged in the electronic circuit and a layout distance between two of the plurality of components;
a calculation device to obtain contour information about the plurality of components from the storage device and to calculate a contour of a component region for collectively arranging the plurality of components using the obtained contour information and the indicated layout distance; and
a display device to display the calculated contour of the component region on the screen.

2. The electronic circuit design apparatus according to claim 1, wherein:
the indication device indicates a component region to be transformed;
the calculation device transforms the indicated component region; and
the display device displays a transformed component region.

3. The electronic circuit design apparatus according to claim 1, wherein:
the indication device indicates a component region to which attribute information is set; and
the calculation device sets attribute information about each component included in the indicated component region.

4. The electronic circuit design apparatus according to claim 1, wherein:
the indication device indicates a plurality of components that are separately arranged in the electronic circuit; and
the display device collectively displays the indicated plurality of components as a component region.

5. The electronic circuit design apparatus according to claim 1, wherein:
the indication device indicates a component region to be divided; and
the display device separately displays at least one indicated component from among a plurality of components included in the indicated component region and collectively displays remaining components as a component region.

6. The electronic circuit design apparatus according to claim 1, wherein:
the indication device indicates a component region to be divided; and
the calculation device divides the indicated component region into a plurality of component regions; and
the display device displays the plurality of component regions.

7. The electronic circuit design apparatus according to claim 1, wherein:
the indication device indicates a plurality of component regions to be integrated;
the calculation device integrates the indicated plurality of component regions into one component region; and
the display device displays the one component region.

8. The electronic circuit design apparatus according to claim 1, wherein:
the indication device indicates a reference component; and
the calculation device calculates a contour of the component region in consideration of a relative position relation between the indicated reference component and the plurality of components.

9. A computer-readable storage medium storing a program for a computer to design an electronic circuit on a screen, the program causing the computer to perform:
indicating a plurality of components to be collectively arranged in the electronic circuit and a layout distance between two of the plurality of components;
calculating a contour of a component region for collectively arranging the plurality of components using contour information about the plurality of components and the indicated layout distance; and
displaying the calculated contour of the component region on the screen.

10. The storage medium according to claim 9, wherein the program causes the computer to further perform:
indicating a component region to be transformed; and
transforming the indicated component region and displaying a transformed component region.

11. The storage medium according to claim 9, wherein the program causes the computer to further perform:
indicating a component region to which attribute information is set; and
setting attribute information about each component included in the indicated component region.

12. The storage medium according to claim 9, wherein the program causes the computer to further perform:
indicating a plurality of components that are separately arranged in the electronic circuit; and
collectively displaying the indicated plurality of components as a component region.

13. The storage medium according to claim 9, wherein the program causes the computer to further perform:
indicating a component region to be divided;
separately displaying at least one indicated component from among a plurality of components included in the indicated component region; and
collectively displaying remaining components as a component region.

14. The storage medium according to claim 9, wherein the program causes the computer to further perform:
indicating a component region to be divided; and
dividing the indicated component region into a plurality of component regions and displaying the plurality of component regions.

15. The storage medium according to claim 9, wherein the program causes the computer to further perform:
indicating a plurality of component regions to be integrated; and
integrating the indicated plurality of component regions into one component region and displaying the one component region.

16. The storage medium according to claim 9, wherein the program causes the computer to further perform indicating a reference component and the computer calculates a contour of the component region in consideration of a relative position relation between the indicated reference component and the plurality of components.

17. An electronic circuit design method of designing an electronic circuit on a screen comprising:
indicating a plurality of components to be collectively arranged in the electronic circuit and a layout distance between two of the plurality of components;
calculating a contour of a component region for collectively arranging the plurality of components using contour information about the plurality of components and the indicated layout distance; and
displaying the calculated contour of the component region on the screen.
